(19) United States
(12) Patent Application Publication
(10) Pub. No.: US 2026/0059257 A1
(43) Pub. Date: Feb. 26, 2026

(54) ULTRA-LOW LATENCY SPATIAL DETECTION, RECORDING, AND INDICATION OF KEY SOUND EVENTS

(71) Applicant: Samsung Electronics Co., Ltd., Suwon-si (KR)

(72) Inventors: Sean Ryan Bornheimer, Orinda, CA (US); Joseph James Verbeke, San Francisco, CA (US); Alice Hong, San Francisco, CA (US); Nathan Folkman, Carcavelos (PT); Minh Dinh, Los Angeles, CA (US)

(21) Appl. No.: 18/812,996

(22) Filed: Aug. 22, 2024

(51) Int. Cl. H04S 7/00

(52) U.S. Cl. CPC H04S 7/304; H04S 2400/11; H04S 2400/15

(57) ABSTRACT

A method includes obtaining an audio signal associated with an audio event in an environment surrounding a user. The method also includes obtaining an inertial measurement unit (IMU) signal from at least one audio device worn by the user, the IMU signal associated with a head position and motion of the user. The method further includes obtaining user information indicating a location and an activity of the user. The method also includes processing the audio signal, the IMU signal, and the user information using a ranking algorithm to determine a total intervention score. The method further includes determining whether to provide an auditory intervention to the user regarding the audio event based on the total intervention score.

### TECHNICAL FIELD

This disclosure relates generally to audio processing in electronic devices. More specifically, this disclosure relates to ultra-low latency spatial detection, recording, and indication of key sound events.

### BACKGROUND

Headphone usage has increased over time with many people today wearing headphones for large portions of the day. Today they are an integral part of how many people experience the world. The popularity of active noise cancelling (ANC) headphones and loud music leads to a loss of situational awareness and reduces the user's natural hearing capability. Specifically, this creates safety issues and issues in connecting with people and information in the environment.

### SUMMARY

This disclosure relates to ultra-low latency spatial detection, recording, and indication of key sound events.

In a first embodiment, a method includes obtaining an audio signal associated with an audio event in an environment surrounding a user. The method also includes obtaining an inertial measurement unit (IMU) signal from at least one audio device worn by the user, the IMU signal associated with a head position and motion of the user. The method further includes obtaining user information indicating a location and an activity of the user. The method also includes processing the audio signal, the IMU signal, and the user information using a ranking algorithm to determine a total intervention score. The method further includes determining whether to provide an auditory intervention to the user regarding the audio event based on the total intervention score.

In a second embodiment, an electronic device includes at least one processing device configured to obtain an audio signal associated with an audio event in an environment surrounding a user. The at least one processing device is also configured to obtain an IMU signal from at least one audio device worn by the user, the IMU signal associated with a head position and motion of the user. The at least one processing device is further configured to obtain user information indicating a location and an activity of the user. The at least one processing device is also configured to process the audio signal, the IMU signal, and the user information using a ranking algorithm to determine a total intervention score. The at least one processing device is further configured to determine whether to provide an auditory intervention to the user regarding the audio event based on the total intervention score.

In a third embodiment, a non-transitory machine-readable medium contains instructions that when executed cause at least one processor of an electronic device to: obtain an audio signal associated with an audio event in an environment surrounding a user; obtain an IMU signal from at least one audio device worn by the user, the IMU signal associated with a head position and motion of the user; obtain user information indicating a location and an activity of the user; process the audio signal, the IMU signal, and the user information using a ranking algorithm to determine a total intervention score; and determine whether to provide an auditory intervention to the user regarding the audio event based on the total intervention score.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example system for spatial sound recognition and reconstruction according to this disclosure;

FIGS. 3A and 3B illustrate an example of the ranking algorithm used in the system of FIG. 2 according to this disclosure;

FIG. 4 illustrates an example look up table of sound types according to this disclosure;

FIG. 5 illustrates an example look up table of typical user state parameters according to this disclosure;

FIG. 6 illustrates an example look up table of sound vector relationships according to this disclosure;

FIG. 7 illustrates an example of the spatial sound playback system used in the system of FIG. 2 according to this disclosure; and

FIG. 8 illustrates an example method for spatial sound recognition and reconstruction according to this disclosure.

### DETAILED DESCRIPTION

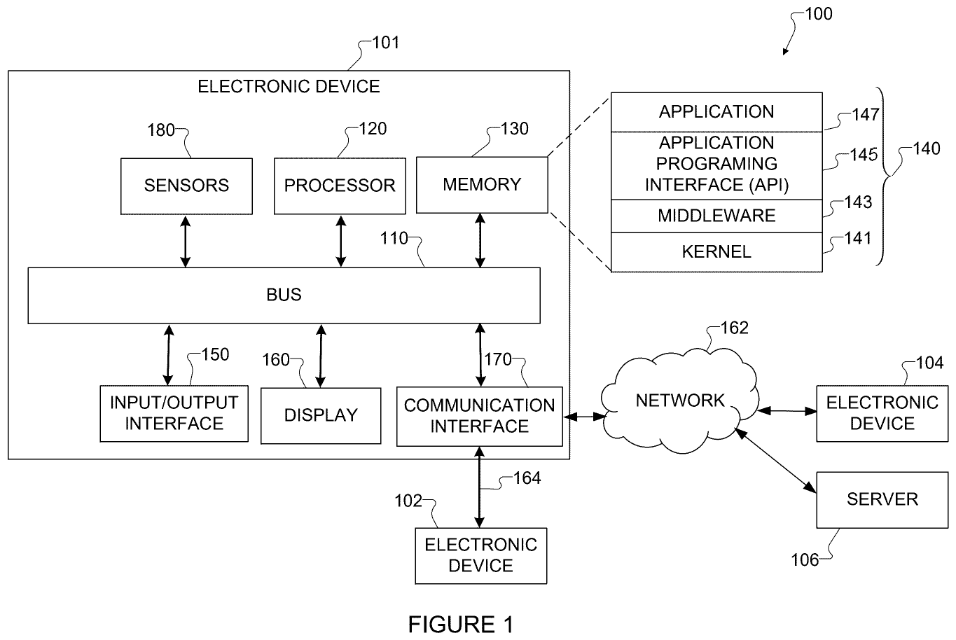

FIGS. 1 through 8, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, headphone usage has increased over time with many people today wearing headphones for large portions of the day (e.g., an average of 3-4 hours/day or more). Today they are an integral part of how many people experience the world. The popularity of active noise cancelling (ANC) headphones and loud music leads to a loss of situational awareness and reduces the user's natural hearing capability. Specifically, this creates safety issues and issues in connecting with people and information in the environment.

As a result, millions of Americans are considered at risk for injury or safety annually due to headphone usage in public settings, particularly while walking, running, or cycling. The number of incidents has increased since noise-cancelling features in headphones was introduced. In fact, one third of headphone wearers report that they have encountered a dangerous situation due to their inability to hear the world and environment while wearing headphones. Eighty percent of headphone wearers indicate that the inability to hear other people talking to them or calling for them while wearing headphones is a major problem. In addition, there are issues with missing audible information (e.g., a public address, a bus stop, a doorbell, or social cues such as a baby crying). This may become worse with the advent of new head-mounted wearables with audio capabilities that are capable of all day ubiquitous wear (such as AR glasses, VR headsets, open wireless earbuds, new AI hearing aids, and the like).

Simply put, wearable audio devices can block or impair a user's hearing, but such devices do not mimic the natural abilities of a person's ears and cognitive sense to hear and prioritize sounds based on spatial location and vector. Human cars naturally detect and process (hear) sounds in a binaural fashion with ultra-low latency (about 0.05 seconds) and independent of the movement of one's body, head, and other moving objects emitting sound (e.g. a bicycle crossing one's path left to right). This provides a person with an innate spatial, situational awareness. A person can hear the trajectory of sound, understand the vector, and innately sense if a collision is imminent or if the sound is important based on this information. When a person wears earbuds or other wearables, their sense of hearing is impaired by the ANC feature or listening to music or a podcast, which can make the person unaware of important sounds and events happening around the person.

There is therefore a need for situation awareness through systems that better augment and complement the human sense of hearing (e.g., spatial audio) while the user wears wearable audio devices. In particular, there is a need for a solution that accurately recreates the spatial situational awareness of the user's natural hearing through earbuds or visual cues. To safely and effectively augment or recreate a person's natural human sense of hearing, the solution should work in much the same way as a person's sense of hearing. To do this, a device should solve for the following problems:

When detecting sounds of importance, conventional approaches fail to consider the spatial location of sounds in relation to the user to properly prioritize sounds of importance (e.g., an ambulance on a street far behind the person may be of low importance or sounds on the street are unimportant while the person is stationary at a café table). Likewise, conventional approaches do not account for the movement or motion of a sound-emitting object in relation to the movement or motion of the person (e.g., a car approaching a person walking in an intersection).

When reproducing sounds or creating alerts, conventional solutions often exhibit a lack of situational awareness. That is, a digital reproduction of environment sounds or sound-related information (e.g., notifications, alerts of a sound, and the like) fails to appropriately match the spatial location of those sounds and the movement of the sound-emitting object in relation to the user (in contrast, a person unencumbered can “feel” a car passing over their shoulder). Also, passed-through environment sounds or sound-related information typically do not accommodate the user's activities, disrupting the listening experience or delivering cognitive load/sense of disorientation.

Conventional approaches attempt to apply sound detection models to mobile devices. However, none of these approaches fully recreates the complex calculations that the human sense of hearing performs, and therefore these augmented experiences do not offer the same spatial awareness as a person's natural hearing, nor are they capable of the subtle layering or mixing of sounds that human natural hearing can provide (e.g., hearing footsteps approach from behind while hiking in the forest). In one example, existing technology lacks an understanding of spatial location and trajectory or vector of the sound(s) and bodies or objects.

Also, conventional sound detection and classification approaches may take into account whether a sound occurs or not, however, such approaches do not do a useful job of determining if a particular sound is a priority for the specific person to hear (much as human cars can quickly prioritize based on distance away, location of sound, and velocity of sound).

Finally, conventional approaches to triggering actions based upon the sound typically do not consider spatial elements which may be important for improving the situational awareness or safety of the person (e.g., provide sound effect, digital effect, or alert in the correct location and matching the velocity of the sound).

This disclosure provides various techniques for ultra-low latency spatial detection, recording, and indication of key sound events. As described in more detail below, the disclosed embodiments enable devices with audio input and output (such as earbuds, speakers, and mobile phones) to passively monitor a user's location and position, detect sounds that are proximate to the user, and determine the activities and context the user is in. While monitoring the sounds, the system can detect and process the sounds using prioritization to provide awareness of the surroundings to the user. In addition, the system can deliver relevant spatial information by simulating the environment sound, which augments or recreates the natural human sense of hearing, therefore giving a sense of safety to the user.

Note that while some of the embodiments discussed below are described in the context of use in consumer electronic devices (such as earbuds), this is merely one example. It will be understood that the principles of this disclosure may be implemented in any number of other suitable contexts and may use any suitable devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform one or more operations for ultra-low latency spatial detection, recording, and indication of key sound events.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for ultra-low latency spatial detection, recording, and indication of key sound events as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an AR wearable device, such as a headset with a display panel or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for ultra-low latency spatial detection, recording, and indication of key sound events.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

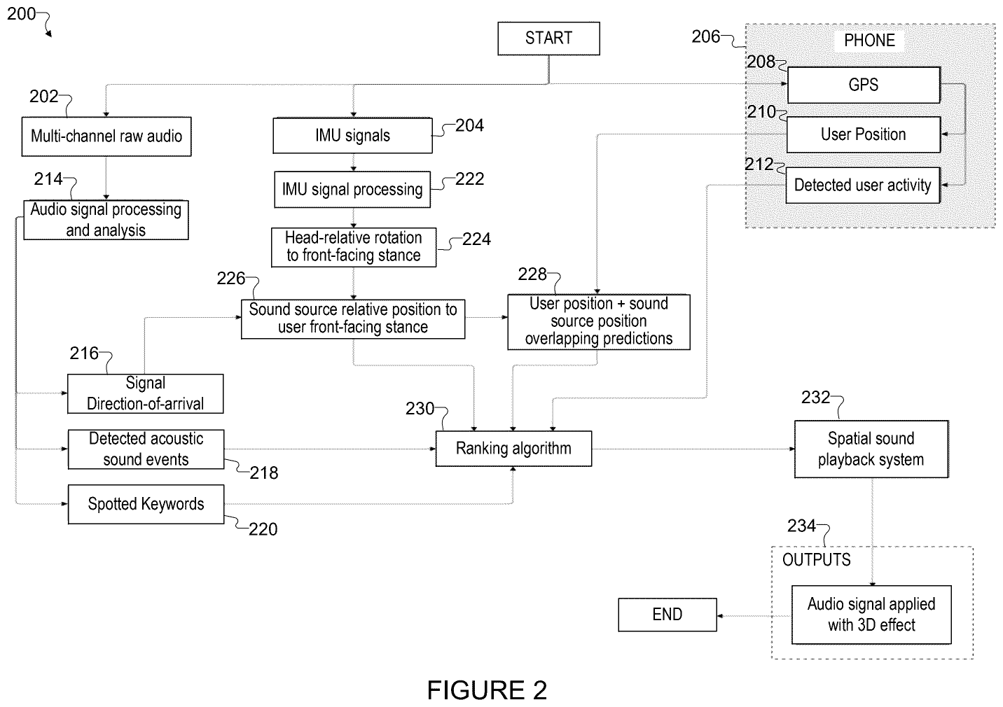

FIG. 2 illustrates an example system 200 for spatial sound recognition and reconstruction according to this disclosure. As described in greater detail below, the system 200 is configured to generate an index of sound information and rank what is critical for users to hear based on the spatial understanding of two bodies in motion. By monitoring and processing sound localization in relation to the user's activities and location, the system 200 can reduce false positives, therefore providing more accurate and relevant spatial information through spatial audio. In addition, the system 200 can deliver contextually relevant spatial sound and information to the user based on the calculated ranking information.

As shown in FIG. 2, the system 200 first obtains multiple inputs, including multi-channel raw audio 202, IMU signals 204, and information obtained from a mobile device 206, such as a mobile phone. The multi-channel raw audio 202 represents one or more audio events surrounding the user, such as voices, traffic noise, music playing nearby, animal sounds, other environmental sounds, and any other sounds that could be perceived by the user. The information from the mobile device 206 can include GPS location information 208 of the user, user position information 210, and detected user activity information 212. The multi-channel raw audio 202 and IMU signals 204 can be obtained from the mobile device 206 or from a separate device, such as earbuds.

After the inputs are obtained, the system 200 performs audio signal processing and analysis 214 on the multi-channel raw audio 202 to determine a signal direction-of-arrival 216, one or more detected acoustic sound events 218, and one or more spotted keywords 220 in the audio 202. The system 200 also performs IMU signal processing 222 on the IMU signals 204 to determine a head-relative rotation to front-facing stance 224. This can include head tracking, tracking of body movement, and the like.

The spatial sounds that are relevant to the user are processed by a sound source relative position to user front-facing stance algorithm 226 and a user position and sound source position overlapping prediction algorithm 228. The sound source relative position to user front-facing stance algorithm 226 determines the spatial relationship between the user and the source of the multi-channel raw audio 202. In some embodiments, the sound source relative position to user front-facing stance algorithm 226 determines a trajectory of the user using the IMU signal and the user information, and also determines a location and trajectory of the source by applying one or more localization techniques to the audio signal. These techniques can include (but are not limited to) any one or more of the following techniques:
Time Difference of Arrival (TDOA): This technique uses the time difference between when a sound wave arrives at different microphones to determine the direction of the sound source. By calculating these time differences, the device can triangulate the position of the sound source.
Sound Intensity Analysis: This technique involves analyzing the intensity of sound at different microphones. The sound source is likely to be closer to the microphone that picks up the highest intensity sound, thus providing a way to localize the sound.
Beamforming: This technique uses multiple microphones to capture sound from different directions. By applying specific delays to each microphone signal, the device can focus on a particular direction, enhancing the sound from that direction while reducing noise from others, thus helping in localizing the sound source.
Direction of Arrival (DOA) Estimation: This technique involves estimating the direction from which a sound wave is arriving. This can be done using various methods, including beamforming, TDOA, and sound intensity analysis.
Machine Learning Algorithms: These can be used to train the device to recognize and localize sound events. By feeding the algorithm large amounts of data, the algorithm can learn to identify patterns and make accurate predictions about the location of sound sources.
Acoustic Vector Sensor (AVS) Technology: AVS uses a combination of pressure and velocity microphones to determine the direction of a sound source. This technology can provide more accurate sound localization compared to traditional microphone arrays.
Steered Response Power with Phase Transform (SRP-PHAT): This is a beamforming technique that estimates the direction of arrival of a sound source by maximizing the output power of the beamformer. It is particularly effective in reverberant environments where other techniques might have difficulty.
Multiple Signal Classification (MUSIC): This is a high-resolution spectral estimation method used for DOA estimation. It is capable of separating signals that arrive at the microphones at nearly the same time, thus improving sound localization accuracy.

The user position and sound source position overlapping prediction algorithm 228 determines a sound source position overlapping prediction based on the locations and trajectories of the user and the source of the audio event. The user position and sound source position overlapping prediction algorithm 228 also determines a sound vector relationship score based on the sound source position overlapping prediction. The sound source relative position to user front-facing stance algorithm 226 and the user position and sound source position overlapping prediction algorithm 228 utilize one or more collision detection techniques to determine if the sound source is likely to collide with a user. In some embodiments, the collision detection techniques use the processed IMU signals 204 and the GPS location information 208 to determine the X, Y, and Z coordinates of the user. The collision detection techniques also use the processed audio signal (such as the signal direction-of-arrival 216) to calculate the position of the audio source relative to the user. Then the collision detection techniques determine when or if a collision between the user and the audio source is going to happen. This is used for prioritizing and ranking what is critical for the user to hear.

Finally, both results of the sound source relative to position to user front-facing stance algorithm 226 and the user position and sound source position overlapping predictions algorithm 228 are processed and combined by the ranking algorithm 230, which uses weighted scores and classifications, as described in greater detail below.

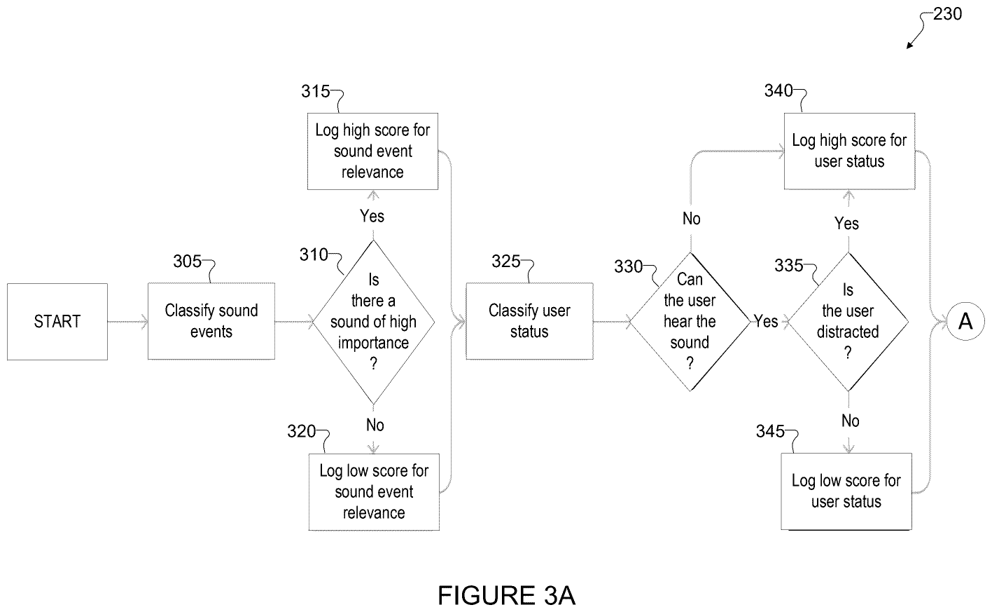

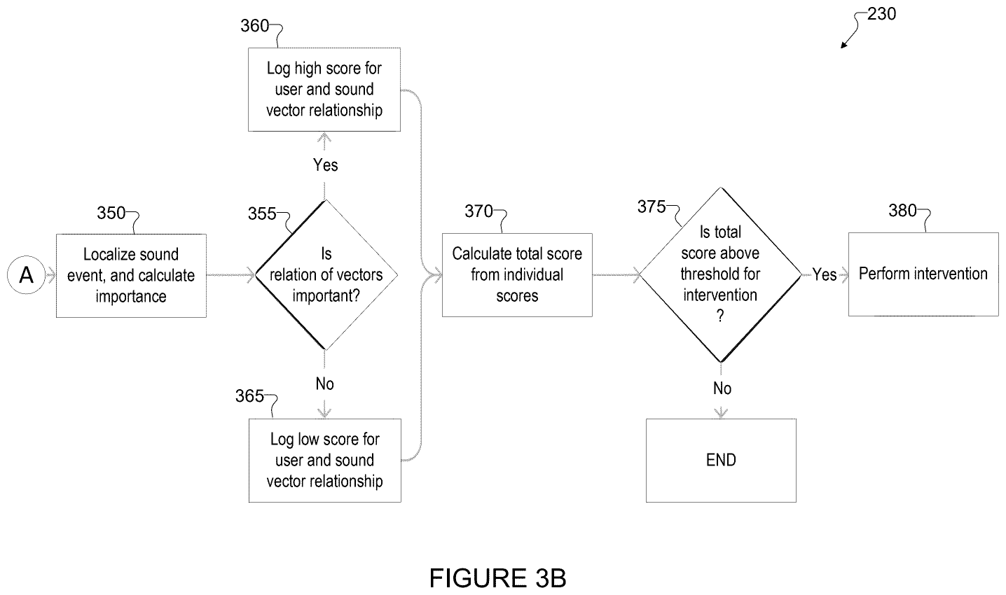

FIGS. 3A and 3B illustrate an example of the ranking algorithm 230 according to this disclosure. As discussed in greater detail below, the ranking algorithm 230 processes scores of the given inputs of the sound source relative position to the user's front-facing stance algorithm 226, detected acoustic sound events 218, spotted keywords 220, detected user activity information 212, user position information 210, and sound source position overlapping prediction algorithm 228.

As shown in FIGS. 3A and 3B, the first part of the ranking algorithm 230 is to determine what sounds are around the user and how important they are. At operation 305, the system 200 obtains and classifies the current detected acoustic sound events 218 based on the importance of each sound event. In some embodiments, the system 200 can leverage an ML-based sound event classifier to classify the detected acoustic sound events 218. Additionally or alternatively, the system 200 can employ a combination of one or more of the following techniques: digital signal processing (such as Fourier and wavelet transforms) to understand frequency and time-frequency components, statistical modeling, or heuristic-based approaches for pattern recognition.

At operation 310, for each detected acoustic sound event 218, the system 200 determines if the sound is of high importance or low importance. In some embodiments, this can include comparing the acoustic sound event 218 to a look up table of typical sound types. If the sound is of high importance, then at operation 315, the system 200 assigns a high score to the classified sound. Otherwise, if the sound is of low importance, then at operation 320, the system 200 assigns a low score to the classified sound.

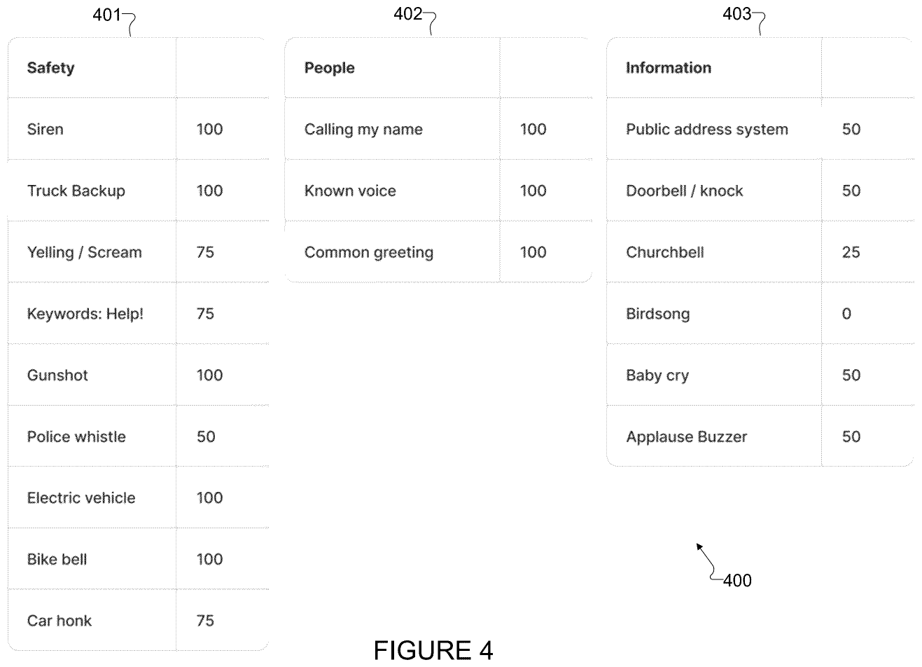

FIG. 4 illustrates an example look up table 400 of sound types according to this disclosure. As shown in FIG. 4, the look up table 400 includes sounds classified into multiple types, including safety sounds 401, people sounds 402, and information sounds 403. Each type of sound is associated with a particular score that ranges from 0 to 100 (although other values and ranges are possible and within the scope of this disclosure), where a higher score indicates higher importance. As an example, if the identified acoustic sound event 218 is classified as a siren, this is considered to be a sound of high importance and is assigned a score of 100.

The next part of the ranking algorithm 230 is to determine whether the user is aware of the sound, in order to understand whether the system 200 should intervene to alert the user of the sound. At operation 325, the system 200 classifies the user state according to multiple parameters associated with the user. For example, during operation 325, the system 200 can check any one or more of the following parameters: the user's headphone type (i.e., whether the user's headphones are open, closed, etc.), the volume of media that the user is listening to (if any), and ANC status (i.e., whether ANC is on or off while the user is listening to media).

At operation 330, the system 200 determines whether the user can hear the acoustic sound event 218 based on the user state and the multiple parameters discussed above. For example, if the user is watching a video at high volume with ANC on, it is very unlikely that the user can hear an external sound event. If the system 200 determines that the user can likely hear the acoustic sound event 218, then at operation 335, the system determines whether the user might be distracted. Here, user distraction may be estimated based on the current user position information 210 and/or the detected user activity information 212, such as whether the user is currently using the user's mobile phone, whether the user is currently interacting with car buds, and the like. User head tracking can also be used to determine if the user is engaged in conversation, reading, and the like.

The system 200 assigns a score based on the user's status. If the system 200 determines (in operation 330) that the user cannot hear the sound or determines (in operation 335) that the user is distracted, then at operation 340, the system 200 assigns a high score for the user state. Otherwise, if the system 200 determines (at operation 335) that the user is not distracted, then at operation 345, the system 200 assigns a low score for the user state. In some embodiments, this can include comparing the user state parameters to a look up table of typical user state parameters.

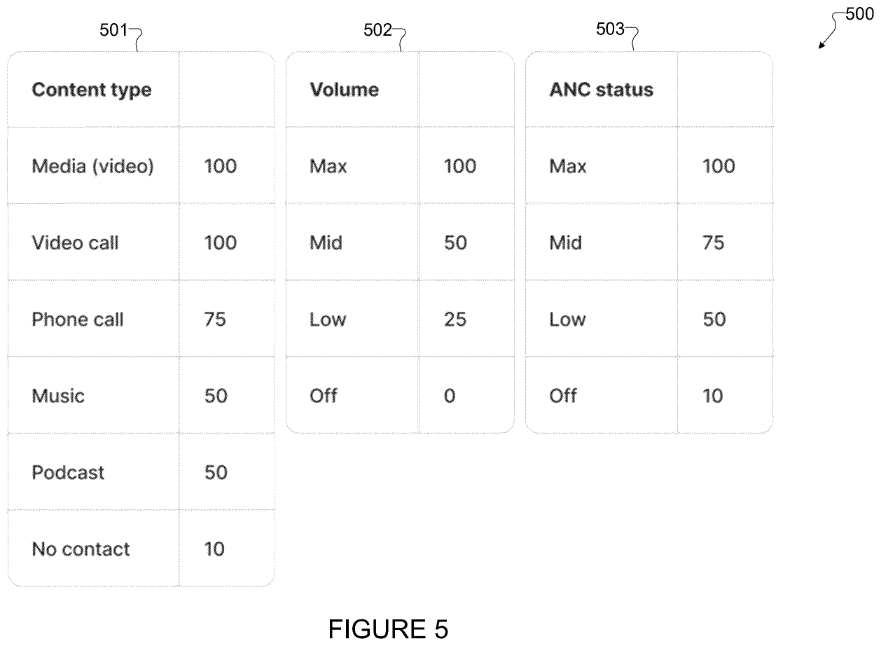

FIG. 5 illustrates an example look up table 500 of typical user state parameters according to this disclosure. As shown in FIG. 5, the look up table 500 includes user state parameters classified into multiple types, including content type 501, media volume 502, and ANC status 503. Each user state parameter is associated with a particular score that ranges from 0 to 100 (although other values and ranges are possible and within the scope of this disclosure), where a higher score indicates that the user is less likely to hear an external sound. Using the earlier example, if the user is watching a video at high volume with ANC on, it is very unlikely that the user can hear an external sound event, and high scores are assigned for these user state parameters.

The next part of the ranking algorithm 230 is to determine whether there is importance in the relationship between the positional vectors of the identified sound and the user, such as the possibility of a collision between the sound source and the user. To accomplish this, at operation 350, the system 200 localizes the acoustic sound event 218 and estimates the importance of the acoustic sound event 218.

At operation 355, the system 200 determines if the relationship between the user vector and the sound vector is of high importance. If the relationship is of high importance, then at operation 360, the system 200 assigns a high score to the user vector and sound vector relationship. Otherwise, if the relationship is of low importance, then at operation 365 the system 200 assigns a low score to the user vector and sound vector relationship. In some embodiments, this can include comparing the relationship to a look up table to determine the score, which can represent the possibility of a collision.

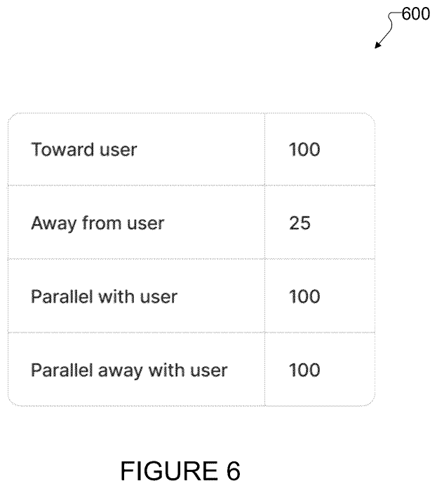

FIG. 6 illustrates an example look up table 600 of sound vector relationships according to this disclosure. As shown in FIG. 6, the look up table 600 includes various directional relationships of a sound vector relative to a user or user vector. Each directional relationship is associated with a particular score that ranges from 0 to 100 (although other values and ranges are possible and within the scope of this disclosure), where a higher score indicates higher importance. As an example, if the sound source of the acoustic sound event 218 is moving toward the user, this is considered to be a relationship of high importance and is assigned a score of 100.

The last part of the ranking algorithm is to determine whether it is necessary for the system 200 to provide an auditory intervention to alert a user about a sound event around the user. At operation 370, the system 200 calculates a total score based on the individual scores logged from the previous steps. In some embodiments, this can include, for example, the system 200 adding the scores determined in operations 315, 320, 340, 345, 360, and 365 to generate the total score. At operation 375, the system 200 compares the total score to a predetermined threshold score to determine whether intervention is necessary. If the total score is less than the threshold score, then the ranking algorithm 230 ends.

Alternatively, if the total score is greater than the threshold score, then at operation 380, the system 200 performs an intervention. As shown in FIG. 2, the intervention involves a spatial sound playback system 232 generating an output 234, which can include an audio signal that may have a 3D effect. In general, the spatial sound playback system 232 simulates the spatial audio at a level that is non-intrusive and at a comfortable level in regard to what the user is listening to. The spatial sound playback system 232 delivers safety-related sounds with ultra-low latency approximate to human hearing. In some embodiments, the spatial sound playback system 232 features sound source separation and filters out the relevant sound from remaining environmental sounds. Further details of the spatial sound playback system 232 are described below.

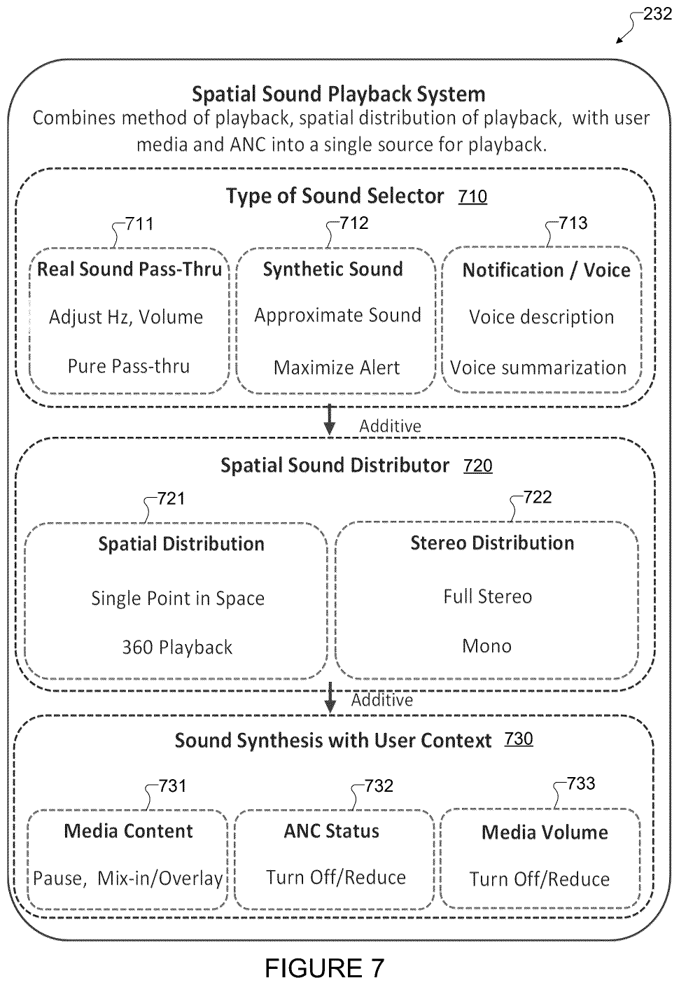

FIG. 7 illustrates an example of the spatial sound playback system 232 according to this disclosure. As shown in FIG. 7, the spatial sound playback system 232 operates to deliver contextually relevant spatial sound(s) and information to the user based on the ranking information calculated by the ranking algorithm 230. In other words, the spatial sound playback system 232 determines how to deliver an auditory notification to the user, based on parameters from the ranking algorithm 230. In general, there are a variety of techniques to bring the user's attention to a particular sound. Some examples include:
Adjust method of alert (e.g., sound effect, voice notification, connect to live person, pass-thru sound, and the like).
Adjust spatial direction of alert (Any of 360 degrees to playback audio or alert directionally).
Adjust user media, such as by adjusting volume control (lower volume or pause content), or ANC/Ambient sound control (Turn off ANC system, Turn on Ambient sound system, etc.).

The optimal selection of output method depends on a variety of factors, which can include the ranking of the sound event (e.g., high priority, low priority, safety related, etc.), the sound duration (Is the sound ephemeral like someone calling your name, or ongoing like a siren?), and direction and trajectory or vector of the sound event. These factors can determine the appropriate response of the spatial sound playback system 232. The spatial sound playback system 232 then adjusts the method of alert (e.g. pass-thru, sound effect), the spatial direction of alert, and the synthesis with user media (e.g. mix-in to content, pause or reduce).

As shown in FIG. 7, the spatial sound playback system 232 includes a type of sound selector 710, a spatial sound distributor 720, and a sound synthesis with user content module 730.

The type of sound selector 710 determines the type of sound a user will hear based on the factors discussed above. The type of sound that the user will hear can include any of multiple sound types, including a real sound pass-through 711, a synthetic sound 712, and a notification/voice sound 713.

A real sound pass-through 711 can include a pass-through of real-world sounds that have been detected in the surrounding environment. Some examples of sounds that can simply be passed through include a safety sound that is not uncomfortable to hear (e.g., a sound of a car or bike passing by) or the voice of an important person, such as a friend. In some embodiments, the passed-through sound can be adjusted for the user. For example, the frequency or volume of the sound could be adjusted for comfort. If the sound is a real voice, the sound can be adjusted for clarity and enhancement of the real voice.

A synthetic sound 712 can be generated and transmitted to the user when the actual sound may be uncomfortable to hear (e.g., a loud or annoying sound like an ambulance) and a synthetic version can convey the same information. Also, when the sound is ephemeral or short in duration (e.g., a doorbell, a bike bell), a synthetic sound 712 can replace the short sound.

A notification/voice sound 713 can be generated and transmitted when the actual sound detected in the surrounding environment is a person's voice and the actual sound may need to be modified in some way. For example, an ephemeral voice message (e.g., a friend calling the user's name) would need to be recorded or recreated or a notification played. A distorted voice (e.g., a voice with heavy background noise, truncated voice, etc.) would need to be enhanced in some way. Also, an announcement or public address (e.g., “Your order is ready”) may need a notification to the user.

The spatial sound distributor 720 controls the spatialization, or lack thereof, and placement of the chosen sound from the type of sound selector 710 for playback to the user. The spatialization can include both spatial distribution 721 and stereo distribution 722. The spatial distribution 721 refers to whether the sound is generated as a point source, a 360 degree source, or something in between. In most situations, it is preferrable to playback in a spatial distribution as this can better replicate the real-life sound and provide more information to the user (e.g., a car or bicycle passing by the user). In some embodiments, a three-dimensional effect can be applied to the sound to deliver ultra-low latency realistic spatial sound to the user, therefore raising one's awareness of the surroundings. For example, the three-dimensional effect can be applied to the intervention, where the three-dimensional effect is selected from right, left, up, down, front, and back directions in relation to the user.

When the sound is of a highly critical, time sensitive nature—particularly related to safety—then the spatial sound distributor 720 can divert to stereo distribution 722 to maximize the ability to get the attention of the person. This could also take into account the user's physical state or position (for example, the user has her head down looking at the phone and a dangerous collision is imminent).

The sound synthesis with user content module 730 controls how additional functionalities of the user's audio device and media are impacted by the system. The additional functionalities can include media content 731, ANC status 732, and media volume 733. As an example of media content 731, in an urgent situation, the media would be paused; however, in less urgent situations, the sound could be “mixed-in” to the media (e.g. a doorbell sound). As an example of ANC status 732, in an urgent situation, ANC would be turned off; however, in less urgent situations (e.g., a public address announcement on a subway), ANC could simply be reduced. As an example of media volume 733, in an urgent situation, the volume would be off; however, in a less urgent situation it would just be removed.

To better illustrate the performance of the system 200, a couple of illustrative scenarios will now be described.

As one example, a siren (such as from an ambulance or emergency vehicle) can be detected. Such a siren has a high correlation with safety, however, the sound's importance to an individual person is strongly related to the context, specifically, is the object emitting the siren likely to collide with the person, and does the person have enough awareness of the siren sound to avoid it. Consider a scenario where a person is wearing ANC headphones, with loud music playing while walking on the street and approaching a small intersection that lacks a stoplight when an ambulance siren starts. When applied to the ranking algorithm 230, the siren sound scores high on the sound detection variable, since the sound has “emergency situation” safety importance. Also, if the collision algorithm predicts a high potential for collision (collision predicted), the sound would be at maximum importance. In addition, the user's awareness of the sound can be measured by the current state of the user (e.g., wearing headphones, head direction, etc.). In this case, the user may have ANC on and music at maximum volume, which indicates a low awareness particularly when combined with a state of walking. As a result, the system 200 can determined that “immediate intervention is needed,” and the spatial sound playback system 232 can determine an appropriate output 234. For example, maximum attention should be attained by turning off all headphone settings, and immediately passing through the sound in a spatially accurate way (e.g., pause music, turn on ambient sound, provide notification, etc.). In the same example, if the user is inside and stationary, then no collision is possible and no intervention is needed (i.e., the siren poses no threat). If the siren is behind the user and moving away from the user (as determined by the collision algorithm), then the siren poses a low threat and a less intrusive intervention is needed. Accordingly, a spatial playback would be delivered (e.g., synthetic sound mixed into content may be appropriate).

As another example, a person yelling nearby can be important from a safety and connection standpoint. The person may be yelling in need of help, yelling to warn the user, or yelling because they mean to harm the user or someone else nearby. The yelling sound's importance to the user is strongly related to the trajectory/vector, specifically, if the yelling person will collide with or approach near the user. In addition, it is important to determine if the user has enough awareness of the yelling sound to respond to it. Consider a scenario where a person is wearing ANC headphones, with loud music playing while walking on the street and approaching an urban square with a person yelling as they approach the wearer from the rear. When applied to the ranking algorithm 230, the sound (once detected) would score highly on the sound detection variable, as the sound has “emergency situation” safety potential. Also, the collision algorithm predicts moderate importance due to close proximity of the sound vector. In addition, the user's awareness of the sound can be measured by the current state of the user's headphones. In this case the user has ANC on and music at maximum volume, which indicates low awareness particularly when combined with a state of walking. As a result, the system 200 should apply high priority to the yelling sound and apply a spatial playback system function appropriate for an ephemeral (non-repeating) sound such as a phrase that is yelled. In this case, a voice alert can be generated because the yelled phrase may not be repeated. In the same example, if the yelling is far away from the user and moving away from the user (as determined by the collision algorithm), then the yelling may pose a very low threat and no intervention is needed.

In some instances of an important voice nearby (such as a person yelling), it may be beneficial to simply play back the actual yelling sound. This would involve capturing and recording the voice related to an important event nearby, storing it, and then playing it back to the user in the case that it is deemed by the system to be of importance. In this case, other elements could be applied to the voice to improve the experience. For example, any background noise or artifacts could be removed (using noise suppression algorithms or other techniques) and the quality of the voice could be sharpened (using voice enhancement algorithms and other techniques) to make it easier for the user to hear and understand what the person said. Finally, the playback of the actual voice could be distributed in a spatial location that is representative of where the person talking/yelling is in relation to the user.

In some instances, it may be beneficial to summarize what was said for brevity and time saving. This would involve capturing, recording, and in some instances, transcribing the voice related to an important event nearby, storing it, and then running a text summarization model on the data. The summarization of the voice could then be played back to the user. In this case, other elements could be applied to the voice to improve the experience. For example, voice cloning software could be used to play back the summarized content in a voice that approximates the actual voice, Any background noise or artifacts could be removed (using noise suppression algorithms or other), and the quality of the voice could be sharpened (using voice enhancement algorithms or just by generating a new voice) to make it easier for the user to hear and understand what the person said. Finally, the playback of the actual voice could be distributed in a spatial location that is representative of where the person talking/yelling is in relation to the user.

As yet another example, a bike bell could be detected by the system 200. In general, a bike bell can be important to hear from a safety standpoint, however, only when the trajectory of the bike presents a danger relative to the user's location and trajectory. Therefore, the sound's importance to the user is strongly related to the trajectory/vector, specifically, if the bike may collide with the user. In addition, it is important to determine if the user has enough awareness of the bike bell sound to respond to it. If a user is listening to music (with or without ANC), the user is unlikely to hear a bike bell. When applied to the ranking algorithm 230, the sound (once detected) would score highly on the sound detection variable as it has emergency situation safety potential. Also, the collision algorithm predicts moderate importance due to close proximity of the sound vector. In addition, the user's awareness of the sound can be measured by the current state of the user's headphones. As a result, the system 200 can apply high priority to this sound and apply a spatial playback system function appropriate for an ephemeral (non-repeating) bike bell sound. In this case, a synthetic version of a bike bell sound can be generated because the bike bell sound may not be repeated. Furthermore, this synthetic, generated sound can be played quickly in a spatially accurate way to properly convey the information to the user. In the same instance, if the bike (and bike bell) is moving in a trajectory that presents no danger to the user (as determined by the collision algorithm), then the sound poses a very low threat and no intervention is needed.

In some embodiments, the system 200 can include functionality to test the user's hearing ability (or provide the ability for the user to manually input this information into the system 200). This can further improve the system's functionalities. For example, the inclusion of information indicating an impaired natural hearing capability enables a more sensitive ranking algorithm 230 that assumes a wider range of sounds are imperceptible to the user and therefore may be ranked as important for the system to bring to the user's attention. User hearing capability information can enable a tailored approach within the spatial sound playback system 232. For example, the method of sound spatial playback and adjustment of the user's media content can all be optimized to ensure that the auditory information is conveyed to the user with impaired hearing abilities.

Additionally, the system 200 could incorporate multimodal outputs (beyond audio) to ensure the intervention reaches the user. For example, if the user is wearing glasses with visual capabilities (a display or lights) a visual indication could appear. If the user is wearing a device with haptics (e.g., a watch, band, ring, pendent, etc.), a haptic or other modality could be leveraged to ensure intervention. If the user is currently interacting with their phone, a visual/textual notification could appear.

In some embodiments, the system 200 can include hardware and/or software that is capable of understanding the user's neural signals and can be leveraged to further improve the system's functionalities. For example, the inclusion of EEG sensing enables an understanding if the user has cognitively attended to the external sound event, as a parameter for determining whether the system needs to intervene. EEG sensing also enables the system 200 to determine whether the user has cognitively attended to a spatial sound, after the spatial sound has been output to the user.

Additionally, the system 200 could incorporate multimodal outputs (beyond audio) to ensure the intervention reaches the user. For example, if the user is currently interacting with their phone, a visual/textual notification could appear. Or, if a sound is played to the user, and the system 200 determines the user did not attend to it, another modality (such as haptics, visual, etc.) could be leveraged to ensure intervention.

In some embodiments, the system 200 can include capabilities for visual sensing. For example, the system 200 can include hardware and/or software that enables the system 200 to understand the visual world around the user (e.g., cameras, LiDAR, etc.). Visual sensing can improve the core functionality of the system 200, as well as enable additional functionality. For example, silent external event understanding can enable the system 200 to determine additional silent events occurring around the user that may require intervention. For example, a user's friend waving to them from across the street or the sound of an electric vehicle. As another example, multimodal localization of sound events can leverage both computer vision and audio as input. In addition, image classification models are typically more advanced than their audio counterparts, therefore, the sound event classification step can be greatly benefited by the inclusion of vision sensing.

It is noted that, while riding in a car or vehicle, one's senses may be impaired in a similar fashion to wearables and consumer technology. By applying the core functionality of the system 200 to a scenario in a car, the user's safety and comfort while riding in a vehicle can be improved, as well as enabling additional functionality. Some examples include:
Alert to Safety Events: Sirens, trucks backing up, people yelling on the street, bike bells, and the like, are all important while driving or sitting in a car.
Multimodal Alert: Vehicles have multi-modal methods for alerting, which could be leveraged. For example, lighting within the vehicle, displays within the vehicle, haptics within the vehicle, or speakers within the vehicle.
Autonomous/Semi-Autonomous Driving Sensors: The system 200 can be combined with existing vehicle sensing systems (LIDAR, camera, radar, and the like) and related software to give a broader and more accurate picture of objects of importance near the vehicle.
Autonomous/Semi-Autonomous Driving Systems: The system 200 can be used to automate or inform driving systems within the vehicle (e.g., safety restraints/seat belts, airbags, seats, braking, steering, acceleration, headlights, turn signals, suspension, tires, and the like).

In some embodiments, the incorporation of audio ray tracing and techniques for acoustic environment modeling enable the system 200 to playback sound (generated, synthetic, digital sound) in a way that is indistinguishable from how our ears here audio naturally in the world. For example, the inclusion of natural audio playback enables a more accurate and natural playback that considers the unique acoustics of an environment including reverb and echo or sound artifacts within the environment.

In some embodiments, the integration of audio-ray tracing of real-world sounds and systems into extended reality (XR) experiences across various sectors, especially in industrial, factory, and medical settings, enhances realism, increases immersion, and can significantly improve the understanding of real-world sounds in combination with the overlaid simulated sounds. For example, in the significant areas where XR is making a profound impact, such as task performance, training, and skill development in factory settings and other industrial environments, the system 200 can provide the following features:
1. A more sensitive ranking algorithm 230 for the combinations of real-world and simulated sounds assumes a wider range of sounds are outside the user's focus (e.g., machinery malfunctions, fire outbreaks, sound alarms, sirens). Therefore, these may be ranked as important for the system 200 to bring to the user's attention through an alternative method using the spatial playback system.
2. A tailored approach within the spatial sound playback system 234 optimizes the method of sound, spatial playback, and adjustment of the user's media content to ensure that auditory information is conveyed to the user without overloading them with sound inputs.

Although FIGS. 2 through 7 illustrate one example of a system 200 for spatial sound recognition and reconstruction and related details, various changes may be made to FIGS. 2 through 7. For example, while the system 200 is described as involving specific sequences of operations, various operations described with respect to FIGS. 2 through 7 could overlap, occur in parallel, occur in a different order, or occur any number of times (including zero times). Also, the specific operations shown in FIGS. 2 through 7 are examples only, and other techniques could be used to perform each of the operations shown in FIGS. 2 through 7.

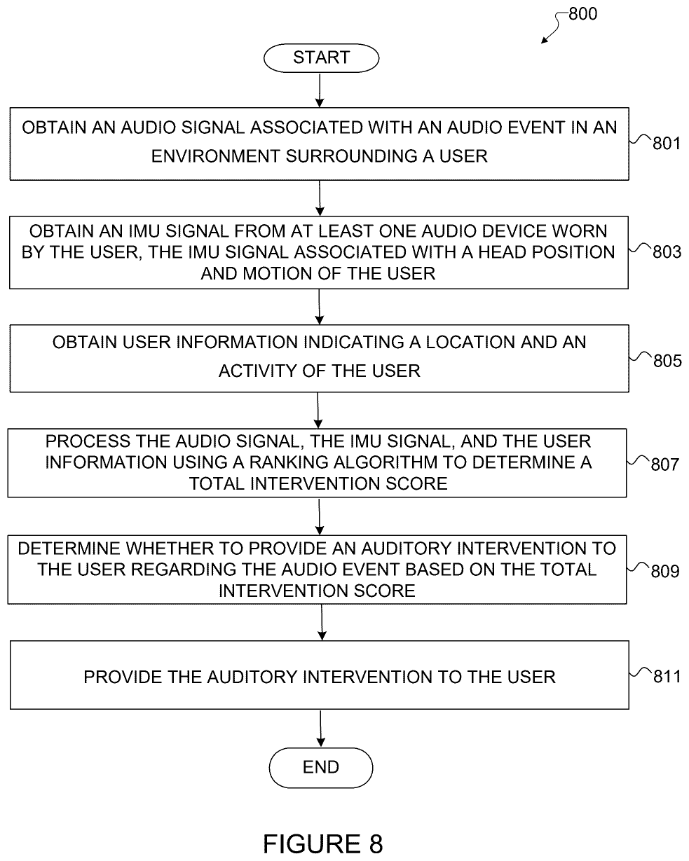

FIG. 8 illustrates an example method 800 for spatial sound recognition and reconstruction according to this disclosure. For ease of explanation, the method 800 shown in FIG. 8 is described as being performed using the electronic device 101 shown in FIG. 1 and the system 200 shown in FIGS. 2 through 7. However, the method 800 shown in FIG. 8 could be used with any other suitable device(s) or system(s) and could be used to perform any other suitable process(es).

As shown in FIG. 8, at step 801, an audio signal is obtained that is associated with an audio event in an environment surrounding a user. This could include, for example, the electronic device 101 obtaining the multi-channel raw audio 202, such as shown in FIG. 2.

At step 803, an IMU signal is obtained from at least one audio device worn by the user. The IMU signal is associated with a head position and motion of the user. This could include, for example, the electronic device 101 obtaining the IMU signals 204, such as shown in FIG. 2.

At step 805, user information indicating a location and an activity of the user is obtained. This could include, for example, the electronic device 101 obtaining the GPS location information 208 of the user, user position information 210, and detected user activity information 212 from the mobile device 206, such as shown in FIG. 2.

At step 807, the audio signal, the IMU signal, and the user information are processed using a ranking algorithm to determine a total intervention score. This could include, for example, the electronic device 101 using the ranking algorithm 230, such as shown in FIGS. 2, 3A, and 3B. In some embodiments, processing the audio signal, the IMU signal, and the user information using the ranking algorithm to determine the total intervention score includes processing the audio signal to determine an importance score indicating an importance of the audio event; processing the IMU signal and the user information to determine a user state score indicating whether the user is aware of the audio event; processing the audio signal, the IMU signal, and the user information to determine a sound vector relationship score indicating a possibility of a collision between the user and a source of the audio event; and determining the total intervention score based on the importance score, the user state score, and the sound vector relationship score.

In some embodiments, processing the audio signal, the IMU signal, and the user information to determine the sound vector relationship score includes determining a trajectory of the user using the IMU signal and the user information; determining a location and trajectory of the source of the audio event by applying one or more localization techniques to the audio signal; determining a sound source position overlapping prediction based on the locations and trajectories of the user and the source of the audio event; and determining the sound vector relationship score based on the sound source position overlapping prediction.

At step 809, it is determined whether to provide an auditory intervention to the user regarding the audio event based on the total intervention score. This could include, for example, the electronic device 101 determining to use the spatial sound playback system 232 to generate an auditory intervention output 234, such as shown in FIGS. 2 and 7.

At step 811, the auditory intervention is provided to the user regarding the audio event. This could include, for example, the electronic device 101 generating the output 234 and outputting the output 234 to the user (e.g., via the earbuds) such as shown in FIG. 2. In some embodiments, providing the auditory intervention to the user regarding the audio event includes determining a type of the auditory intervention from among multiple candidate alert methods; determining a spatial direction of the auditory intervention; determining one or more audio settings of the at least one audio device; and transmitting the auditory intervention via the at least one audio device based on the method of the auditory intervention, the spatial direction, and the one or more audio settings.

Although FIG. 8 illustrates one example of a method 800 for spatial sound recognition and reconstruction, various changes may be made to FIG. 8. For example, while shown as a series of steps, various steps in FIG. 8 could overlap, occur in parallel, occur in a different order, or occur any number of times (including zero times).

Note that the operations and functions shown in or described with respect to FIGS. 2 through 8 can be implemented in an electronic device 101, 102, 104, server 106, or other device(s) in any suitable manner. For example, in some embodiments, the operations and functions shown in or described with respect to FIGS. 2 through 8 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2 through 8 can be implemented or supported using dedicated hardware components. In general, the operations and functions shown in or described with respect to FIGS. 2 through 8 can be performed using any suitable hardware or any suitable combination of hardware and software/firmware instructions.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining an audio signal associated with an audio event in an environment surrounding a user;
obtaining an inertial measurement unit (IMU) signal from at least one audio device worn by the user, the IMU signal associated with a head position and motion of the user;
obtaining user information indicating a location and an activity of the user;
processing the audio signal, the IMU signal, and the user information using a ranking algorithm to determine a total intervention score; and
determining whether to provide an auditory intervention to the user regarding the audio event based on the total intervention score.

2. The method of claim 1, wherein processing the audio signal, the IMU signal, and the user information using the ranking algorithm to determine the total intervention score comprises:
processing the audio signal to determine an importance score indicating an importance of the audio event;
processing the IMU signal and the user information to determine a user state score indicating whether the user is aware of the audio event;
processing the audio signal, the IMU signal, and the user information to determine a sound vector relationship score indicating a possibility of a collision between the user and a source of the audio event; and
determining the total intervention score based on the importance score, the user state score, and the sound vector relationship score.

3. The method of claim 2, wherein processing the audio signal, the IMU signal, and the user information to determine the sound vector relationship score comprises:
determining a trajectory of the user using the IMU signal and the user information;
determining a location and trajectory of the source of the audio event by applying one or more localization techniques to the audio signal;
determining a sound source position overlapping prediction based on the locations and trajectories of the user and the source of the audio event; and
determining the sound vector relationship score based on the sound source position overlapping prediction.

4. The method of claim 1, further comprising:
providing the auditory intervention to the user regarding the audio event, comprising:
determining a type of the auditory intervention from among multiple candidate alert methods;
determining a spatial direction of the auditory intervention;
determining one or more audio settings of the at least one audio device; and
transmitting the auditory intervention via the at least one audio device based on the method of the auditory intervention, the spatial direction, and the one or more audio settings.

5. The method of claim 4, wherein the type of the auditory intervention, the spatial direction, and the one or more audio settings are determined based on at least one of: a priority ranking of the audio event, a duration of the audio event, and a trajectory of the audio event relative to the user.

6. The method of claim 4, wherein the type of the auditory intervention comprises a real sound pass-through, a synthetic sound that approximates the audio event, or a spoken notification.

7. The method of claim 4, wherein determining the spatial direction of the auditory intervention comprises:
applying a three-dimensional effect to the auditory intervention in at least one direction from among right, left, up, down, front, and back directions based on a trajectory of a source of the audio event.

8. An electronic device comprising:
at least one processing device configured to:
obtain an audio signal associated with an audio event in an environment surrounding a user;
obtain an inertial measurement unit (IMU) signal from at least one audio device worn by the user, the IMU signal associated with a head position and motion of the user;
obtain user information indicating a location and an activity of the user;
process the audio signal, the IMU signal, and the user information using a ranking algorithm to determine a total intervention score; and
determine whether to provide an auditory intervention to the user regarding the audio event based on the total intervention score.

9. The electronic device of claim 8, wherein to process the audio signal, the IMU signal, and the user information using the ranking algorithm to determine the total intervention score, the at least one processing device is configured to:
process the audio signal to determine an importance score indicating an importance of the audio event;
process the IMU signal and the user information to determine a user state score indicating whether the user is aware of the audio event;
process the audio signal, the IMU signal, and the user information to determine a sound vector relationship score indicating a possibility of a collision between the user and a source of the audio event; and
determine the total intervention score based on the importance score, the user state score, and the sound vector relationship score.

10. The electronic device of claim 9, wherein to process the audio signal, the IMU signal, and the user information to determine the sound vector relationship score, the at least one processing device is configured to:
determine a trajectory of the user using the IMU signal and the user information;
determine a location and trajectory of the source of the audio event by applying one or more localization techniques to the audio signal;
determine a sound source position overlapping prediction based on the locations and trajectories of the user and the source of the audio event; and
determine the sound vector relationship score based on the sound source position overlapping prediction.

11. The electronic device of claim 8, wherein the at least one processing device is further configured to:
provide the auditory intervention to the user regarding the audio event, comprising:
determine a type of the auditory intervention from among multiple candidate alert methods;
determine a spatial direction of the auditory intervention;
determine one or more audio settings of the at least one audio device; and
transmit the auditory intervention via the at least one audio device based on the method of the auditory intervention, the spatial direction, and the one or more audio settings.

12. The electronic device of claim 11, wherein the type of the auditory intervention, the spatial direction, and the one or more audio settings are determined based on at least one of: a priority ranking of the audio event, a duration of the audio event, and a trajectory of the audio event relative to the user.

13. The electronic device of claim 11, wherein the type of the auditory intervention comprises a real sound pass-through, a synthetic sound that approximates the audio event, or a spoken notification.

14. The electronic device of claim 11, wherein to determine the spatial direction of the auditory intervention, the at least one processing device is configured to:
apply a three-dimensional effect to the auditory intervention in at least one direction from among right, left, up, down, front, and back directions based on a trajectory of a source of the audio event.

15. A non-transitory machine-readable medium containing instructions that when executed cause at least one processor of an electronic device to:
obtain an audio signal associated with an audio event in an environment surrounding a user;
obtain an inertial measurement unit (IMU) signal from at least one audio device worn by the user, the IMU signal associated with a head position and motion of the user;
obtain user information indicating a location and an activity of the user;
process the audio signal, the IMU signal, and the user information using a ranking algorithm to determine a total intervention score; and
determine whether to provide an auditory intervention to the user regarding the audio event based on the total intervention score.

16. The non-transitory machine-readable medium of claim 15, wherein the instructions to process the audio signal, the IMU signal, and the user information using the ranking algorithm to determine the total intervention score, comprise instructions to:
process the audio signal to determine an importance score indicating an importance of the audio event;
process the IMU signal and the user information to determine a user state score indicating whether the user is aware of the audio event;
process the audio signal, the IMU signal, and the user information to determine a sound vector relationship score indicating a possibility of a collision between the user and a source of the audio event; and
determine the total intervention score based on the importance score, the user state score, and the sound vector relationship score.

17. The non-transitory machine-readable medium of claim 16, wherein the instructions to process the audio signal, the IMU signal, and the user information to determine the sound vector relationship score, comprise instructions to:
determine a trajectory of the user using the IMU signal and the user information;
determine a location and trajectory of the source of the audio event by applying one or more localization techniques to the audio signal;
determine a sound source position overlapping prediction based on the locations and trajectories of the user and the source of the audio event; and
determine the sound vector relationship score based on the sound source position overlapping prediction.

18. The non-transitory machine-readable medium of claim 15, wherein the instructions further cause the at least one processor to:
provide the auditory intervention to the user regarding the audio event, comprising:
determine a type of the auditory intervention from among multiple candidate alert methods;
determine a spatial direction of the auditory intervention;
determine one or more audio settings of the at least one audio device; and
transmit the auditory intervention via the at least one audio device based on the method of the auditory intervention, the spatial direction, and the one or more audio settings.

19. The non-transitory machine-readable medium of claim 18, wherein the type of the auditory intervention, the spatial direction, and the one or more audio settings are determined based on at least one of: a priority ranking of the audio event, a duration of the audio event, and a trajectory of the audio event relative to the user.

20. The non-transitory machine-readable medium of claim 18, wherein the type of the auditory intervention comprises a real sound pass-through, a synthetic sound that approximates the audio event, or a spoken notification.
